(19) United States
(12) Patent Application Publication
(10) Pub. No.: US 2013/0248293 A1
(43) Pub. Date: Sep. 26, 2013

(54) Lubricant Separation by Molecular Size and Temperature

(71) Applicants: Gregory Mordukhovich, Bloomfield Hills, MI (US); Eric W. Schneider, Shelby Township, MI (US)

(72) Inventors: Gregory Mordukhovich, Bloomfield Hills, MI (US); Eric W. Schneider, Shelby Township, MI (US)

(73) Assignee: GM GLOBAL TECHNOLOGY OPERATIONS LLC, Detroit, MI (US)

(21) Appl. No.: 13/426,747

(22) Filed: Mar. 22, 2012

(51) Int. Cl. F16N 39/06; F01M 9/00; F01M 1/02

(52) U.S. Cl. 184/6.21

(57) ABSTRACT

A lubrication system in a machine has a lubricant comprising a plurality of differently-sized species of lubricant molecules and a pump that circulates the lubricant to an area of the machine for lubrication, wherein a molecular sieve in the lubrication system adsorbs a species of lubricant molecules in a predetermined lubricant temperature range and desorbs the species of lubricant molecules at temperatures outside the predetermined lubricant temperature range.

### FIELD OF THE SPECIFICATION

The present invention relates to lubrication systems that experience large temperature variations, such as engine lubrication systems, and more specifically to controlling lubricant properties over a wide temperature span.

### INTRODUCTION TO THE DISCLOSURE

This section provides information helpful in understanding the invention but that is not necessarily prior art.

Engine oil lubricates moving components of an engine. For example, oil may lubricate pistons that reciprocate in cylinders, a crankshaft that rotates on bearings, and a camshaft that drives intake and exhaust valves. Oil reduces friction-related wear in the engine. Oil may also coat metal components to inhibit corrosion. A vehicle engine typically includes an oil pan that is mounted to the engine block. Lubricating oil drains from the engine block into and collects in the oil pan sump before being pumped from the oil pan and recirculated through the engine again.

Automotive vehicle engines are operated under a wide range of temperatures. Engine oil creates hydrodynamic drag-related frictional losses when the engine is running. These losses are minimized at a certain viscosity or in a certain viscosity range. The temperature at which the oil is used varies from very cold when an engine is started in winter to very hot after extended operation in summer. Liquids, including engine oils, change viscosity with temperature, typically being less viscous with increasing temperature. Accordingly, oils used for engine lubrication are generally formulated as multigrade oils, which include additives like pour point depressants and viscosity index modifiers, to provide satisfactory lubrication over a fairly broad temperature range, for example SAE 10W-40 and 5W-30 grade oils. Such formulations provide satisfactory, though not optimum, viscosity over much of the temperature range, but the oil viscosity still changes with changes in temperature. In particular, engine oil viscosity at lower temperature is much higher than ideal. There remains a need for an engine lubrication system that can better control lubricant viscosity over a wide temperature operating range for the engine.

### SUMMARY OF THE DISCLOSURE

This section provides a general summary rather than a comprehensive disclosure of the full scope of the invention and of all its features.

We disclose methods and systems that provide lubricants with a larger fraction of lower molecular size or volume lubricant molecules at lower temperatures and a larger fraction of higher molecular size or volume lubricant molecules at higher temperatures by having at least one pore size of molecular sieve selectively adsorbing or releasing, based on lubricant temperature, an amount of a species of lubricant molecules for a lubricant blend of a plurality of species of different molecular volumes. The lubricant species are selectively removed by adsorption by the molecular sieve or released by desorption from the molecular sieve based on molecular volume or size of the lubricant molecules and pore size of the molecular sieve, where the pore size of the molecular sieve changes with lubricant temperature. The molecular sieve employed is selected to have a particular pore size at a desired temperature or in a desired temperature range that will either adsorb or desorb a species of lubricant molecules at that temperature or in that temperature range. The lubricant has a plurality of species of lubricant molecules that differ in molecular volume.

In an embodiment, a lubrication system includes at least one molecular sieve material configured to adsorb a specific size of lubricant molecules, based on molecular volume, in a selected temperature range and to release that size of lubricant molecules in response to a temperature change to a temperature outside of the temperature range. In various embodiments, at least a fraction of lubricant molecules of smaller molecular size, which provides an optimum viscosity at low temperatures but which makes the lubricant's viscosity too low and/or the lubricant's volatility too high at higher temperatures, is adsorbed into a molecular sieve at higher temperatures and released at lower temperatures; concurrently or alternatively, at least a fraction of lubricant molecules of larger molecular volume, which provides an optimum viscosity at higher temperatures but which makes the lubricant's viscosity too high at lower temperatures, is adsorbed at lower temperatures and released at higher temperatures. The lubricant may contain lubricant molecules of a third size that remain in the lubricant at all temperatures.

A lubrication system is provided that has a lubricant sump including an attached or secured or immobile insert comprising a molecular sieve material in contact with lubricant in the sump. The molecular sieve material is configured to adsorb a specific size of lubricant molecules, based on molecular volume, in a selected temperature range and to release that size of lubricant molecules at temperatures outside of the selected temperature range. In various embodiments the molecular sieve material is arranged in channels through which lubricant flows.

In another embodiment, a lubrication system is provided with a section through which lubricant flows, wherein the section has an attached or secured or immobile insert comprising a molecular sieve material that contacts the lubricant flowing through the section. Again, the molecular sieve material is configured to adsorb a specific size of lubricant molecules, based on molecular volume, in a selected temperature range and to release that size of lubricant molecules at temperatures outside of the selected temperature range.

In yet another embodiment, an automotive vehicle includes a lubrication system that circulates lubricant through a section that has an attached or secured or immobile insert comprising a molecular sieve material that contacts the lubricant flowing through the section. The molecular sieve material is configured to adsorb a specific size of lubricant molecules, based on molecular volume, in a selected temperature range and to release that size of lubricant molecules at temperatures outside of the selected temperature range.

In a further particular embodiment, an automotive vehicle is provided with a lubrication system having an engine oil formulated to include a plurality of lubricant molecules differing in molecular volume, wherein the lubrication system further includes at least one molecular sieve material in contact with the oil. The molecular sieve material is configured to adsorb a specific size of lubricant molecules, based on molecular volume, in a selected temperature range and to release that size of lubricant molecules at temperatures outside of the selected temperature range. In various embodiments, the method and system use a lubricant that includes a polyalpha-olefin (PAO) oil including one or more PAO oligomers, such as decene oligomers of different molecular sizes. The lubrication system includes a molecular sieve material in contact with the oil that is configured to adsorb a higher molecular weight oligomer species at a first temperature and release the higher molecular weight oligomer at a second, higher temperature and a second molecular sieve material in contact with the oil that is configured to adsorb a lower molecular weight oligomer species at a third temperature. The second and third temperatures are selected such that there is a temperature range in which the first oligomer species is in the oil below a temperature range in which the second oligomer species is in the oil.

The disclosed lubrication system provides lubricant compositions with more lower molecular weight lubricant molecules to the engine at low temperatures and lubricant compositions with more higher molecular weight lubricant molecules to the engine at high temperatures. This permits greater control of oil viscosity according to operating temperature, which can improve fuel economy and which reduces engine wear. For example, for automotive vehicles a kinematic viscosity between about 4 cSt and 6 cSt is ideal; however, current lubricant systems provide viscosities above 100 cSt at −20° C. and typically do not approach ideal viscosity until the lubricant nears 100° C. The disclosed lubrication system provides lubrication viscosities closer to ideal and may allow a 0.6 to 1.2% improvement in fuel economy (as measured according to a 55/45 combined weighted average of city and highway portions of the US government test procedure (COMFE). Lower lubricant viscosity at cold temperatures also requires lower cold cranking capacity of the battery. The disclosed lubrication system also reduces emissions and oil consumption by removing a fraction of lubricant containing low molecular weight molecules from the lubricant at high temperatures where such low molecular weight molecules would otherwise be volatilized.

The disclosed system is beneficial for similar reasons in other lubrication applications that experience wide temperature changes during operation, including other automotive vehicle lubrication applications, such as transmission and rear axle lubricant systems; aviation engines and other aviation systems requiring lubrication; turbine engines; machine tools, compressors, and other industrial motors and industrial systems that require lubrication.

In describing these methods and devices, certain terms are used that have the following meanings.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The terms “comprises,” “comprising,” “including,” and “having,” are inclusive and therefore specify the presence of stated features, integers, steps, operations, elements, or components, but do not preclude the presence or addition of one or more other features, integers, steps, operations, elements, components, or groups of these. The method steps, processes, and operations described are not to be construed as necessarily requiring their performance in the particular order discussed or illustrated, unless specifically identified as an order of performance. It is also to be understood that additional or alternative steps may be employed. As used in this specification, the term “or” includes any and all combinations of one or more of the associated listed items.

Although the terms first, second, third, etc. may be used herein to describe various elements, components, regions, layers or sections, these elements, components, regions, layers and/or sections should not be limited by these terms. These terms may be only used to distinguish one element, component, region, layer, section, step, etc. from another region, layer, section, step, etc. Terms such as “first,” “second,” and other numerical terms when used herein do not imply a sequence or order unless clearly indicated by the context.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic, partial cross-sectional illustration of a typical engine for a motor vehicle employing a lubrication system;

FIG. 2 is a cross-section of one embodiment of a brick of molecular sieve material used in the lubrication system; and

FIG. 3 is a graph of ideal behavior of average pore size of two molecular sieve materials in a temperature range for operation of an automotive vehicle engine.

### DETAILED DESCRIPTION

A detailed description of exemplary, nonlimiting embodiments follows.

The lubrication system includes a lubricant having lubricant molecules of a plurality of molecular volumes (which will also be referred to as molecular sizes) circulating in the system and a molecular sieve material in contact with the lubricant. The molecular sieve material has a pore size that changes with lubricant temperature during operation of the system, selectively adsorbing and desorbing a species of lubricant molecules of a molecular size in a predetermined lubricant temperature range.

Molecular sieve materials include zeolites, metal organic frameworks (MOFs), and covalent organic frameworks (COFs). Zeolites are porous structures of aluminosilicate. There are both naturally-occurring and synthetic zeolite varieties, the latter being produced by crystallization of silica-alumina gel. Pore size can be affected by controlling the ratio of silica to alumina in the gel and by other factors, such as described in Larsen et al., US Patent Application Publication No. US 2012/0027673 and in Garcia-Martinez, US Patent Application Publication No. US 2012/0024776.

Manufacture and characterization of zeolites and other molecular sieves are well-known and described, for example, in Scott M. Auerback, “Handbook of Zeolite Science and Technology”; W. W. Wong, “Handbook of Zeolites: Structure, Properties, and Applications”; H. Van Bekkum, “Introduction to Zeolite Science and Practice”; Rosemarie Szostak, “Handbook of Molecular Sieves”; and Helmut G. Karge, “Molecular Sieves: Science and Technology,” the entire contents of each being incorporated herein by reference. Zeolites may be manufactured by crystallization from aluminum hydroxide, sodium hydroxide, and water glass. Under carefully controlled conditions, the crystallization process produces the required sodium aluminosilicate structure. The formed zeolite crystals can then be ion exchanged, if need be, to adjust the pores to a desired size. After drying, the zeolite crystals can be processed to activated zeolite powder, beads, or monoliths using well-known methods. A monolith can be used in the lubricant and lubrication system as such. Zeolite powders or beads may be enclosed in a lubricant-permeable container, or attached or molded onto a surface, such as molded into a lubricant-permeable foam.

Other classes of porous crystals are Metal-Organic Frameworks (MOFs), Zeolitic Imidazolate Frameworks (ZIFs), Covalent Organic Frameworks (COFs), and Metal Organic Polyhedra (MOPs). Generally speaking, MOFs are crystalline compounds consisting of metal ions or clusters coordinated to often rigid organic linking molecules to form one-, two-, or three-dimensional porous structures. Based on the combination of the building blocks, the length, and the combination and the functionalization of the organic linker, a large variety of pore environments can be made. MOFs may have large surface areas and are relatively easy to adapt for specific applications. More information is available in Stuart L. James, Chem. Soc. Rev., 2003 32, 276-288, which is incorporated herein by reference.

COFs, covalent organic frameworks, are described for example in Yaghi et al., US 2006/0154807 and 2010/0143693; Apitler et al., “A 2D Covalent Organic Framework with 4.7-nm Pores and Insight into Its Interlayer Stacking,” J. Am. Chem. Soc., 2011, 133(48), pp. 19416-21 (Dec. 7, 2011); Adrien P. Cote et al., “Reticular Synthesis of Microporous and Mesoporous 2D Covalent Organic Frameworks,” J. Am. Chem. Soc. 2007 129, 12914-12915; Hani M. El-Kaderi et al., “Designed Synthesis of 3D Covalent Organic Frameworks,” Science, Vol. 316, 13 Apr. 2007, pp. 268-272; Adrien P. Cote et al., “Porous, Crystalline, Covalent Organic Frameworks,” Science, Vol. 310, 18 Nov. 2005, pp. 1166-1170; and Joon-Sung Ahn et al., “In situ Temperature Tunable Pores of Shape Memory Polyurethane Membranes,” Smart Materials and Structures, Vol 20, No. 10, 2011, each of which is incorporated herein by reference.

The pore size of a molecular sieve within a temperature range is chosen based on the molecule size of the lubricant species that is targeted for adsorption. The molecular sieve material or materials may be designed based on pore size requirements and multi-cycle durability requirements.

The lubricant may be any of those used as engine oils, transmission fluids, hydraulic fluids, gear oils, marine cylinder oils, compressor oils, refrigeration lubricants, aviation turbine oils, gas turbine oils, passenger vehicle engine oils, commercial vehicle engine oils, industrial, marine, hydraulic, aviation, and driveline oils. The lubricant can range in viscosity from light distillate mineral oils to heavy lubricating oils, such as gasoline engine oils, mineral lubricating oils, and heavy duty diesel oils. Many classes of lubricants are known, including American Petroleum Institute (API) categories of Group I through Group V. The API defines Group I stocks as solvent-refined mineral oils. Group I stocks contain the most unsaturates and sulfur and have the lowest viscosity indices. Group II and III stocks are high viscosity index and very high viscosity index base stocks, respectively. The Group III paraffinic and naphthenic oils such as mineral oils contain fewer unsaturates and sulfur than the Group I oils. Group IV oils are poly(alpha-olefin) (PAO) oils. Oligomers of lower molecular weight olefins such as ethylene and propylene, oligomers of ethylene/butene-1 and isobutylenelbutene-1, and oligomers of ethylene with other higher olefins, as described in U.S. Pat. No. 4,956,122 and the patents it references can also be employed. Group V includes all the other base stocks not included in Groups I through IV, such as lubricants based on or derived from esters (e.g. polyol esters), alkylated aromatics, polyinternal olefins (PIOs), polyalkylene glycols (PAGs), silicone oils, fluorinated oils, and ionic fluids.

Typical automotive engine oil compositions use lubricants from Groups I, II, or III, PAOs, or mixtures of these as a base oil stock. PAOs are produced via the catalytic oligomerization of linear alpha-olefins, typically monomers having from about 4 to about 30, or from about 4 to about 20, or from about 6 to about 16 carbon atoms. Examples of useful PAOs include oligomers of C5-C 14 linear alpha-olefins, especially from 1-hexene to 1-tetradecene, more particularly from 1-octene to 1-dodecene, and mixtures of these. Blends of oligomers of 1-decene are one preferred lubricant that may be used in the lubricant system. In another embodiment, the base oil comprises mixtures of mineral oils with PAOs. In yet another embodiment, the base oil comprises a polyinternal olefin (PIO—a group VI base oil).

In various embodiments, the lubrication system includes a fluid pump positioned to draw lubricant past and through the molecular sieve material and to circulate the lubricant to the areas where it is needed. In various embodiments, the lubrication systems include a lubricant or oil sump, and the pump may be positioned to draw lubricant or oil from the sump to circulate pressurized lubricant to the place or places where lubrication is required, after which the lubricant is returned to the sump. In an automotive engine, the oil pump circulates the oil from the sump to the engine parts needing lubrication, after which the oil is returned to the sump by gravity flow.

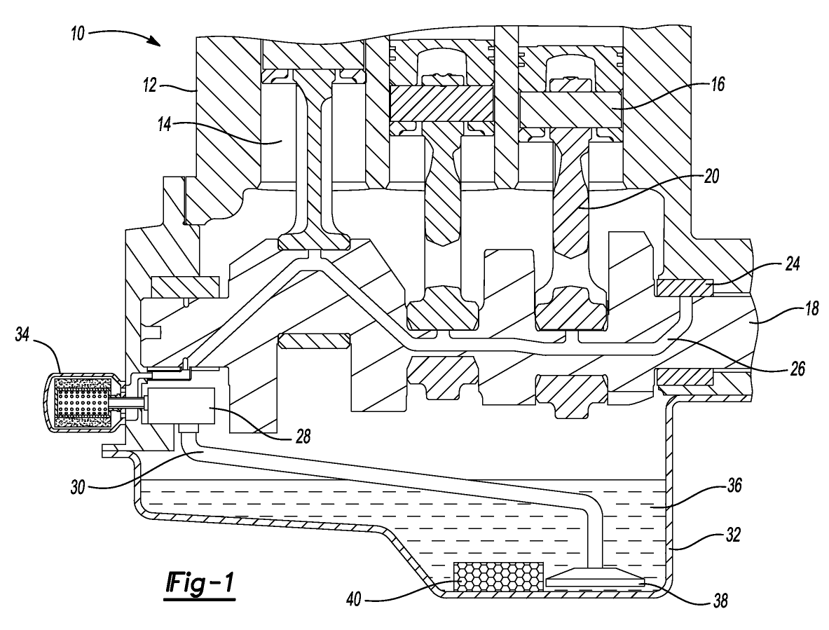

Referring now to the automotive vehicle internal combustion engine shown partially in FIG. 1, engine 10 includes a cylinder case 12 defining a plurality of cylinders 14, each operable to receive a piston 16 for reciprocal motion therein. Each piston 16 imparts torque to a crankshaft 18 via a connecting rod 20 as a result of force generated by combustion of an air-fuel mixture inside each respective cylinder 14. Each connecting rod 20 is rotationally supported on the crankshaft 18 via a rod bearing 22. The crankshaft 18 is rotationally supported in the cylinder case 12 via main bearings 24.

Engine 10 employs a lubrication system 26 having fluid passages or galleries for supplying oil to rod bearings 22, main bearings 24, and other moving parts (not shown). The fluid passages of lubrication system 26 are supplied with oil 36 via an oil pump 28, which first pumps the oil through an oil filter 34. The oil pump 28 employs a pick-up structure 30 projecting from the pump 28, typically concluding with a steel mesh screen 38 to filter out debris, for receiving oil from an oil pan sump 32. Sump 32 contains a brick of molecular sieve material 40, which is attached to sump 32 so as not to interfere with operation of the engine.

Brick 40 comprises a molecular sieve material configured to adsorb and hold lubricant molecules of a particular size in a specific temperature range. The molecular sieve will adsorb the lubricant molecules when it has a pore size that matches the dynamic diameter of the lubricant molecule. The pore size changes with temperature, due to a thermal expansion characteristic of the selected molecular sieve material, which may be determined, for example, as explained in D. S. Bhange et al., “High Temperature Thermal Expansion Behavior of Silicalite-1 Molecular Sieve: In Situ HTXRD Study,” Micropor. Mesopor. Mater., 2007; D. S. Bhange et al., “Negative thermal expansion in silicalite-1 and zirconium silicalite-1 having MFI structure,” Materials Research Bulletin 41 (2006) 1392-1402; M. Lassinantti Gualtieri et al, “Accurate Measurement of the Thermal Expansion of MFI Zeolite Membranes by in situ HTXRPD,” Studies in Surface Science and Catalysts, Vol. 154, Part A, 2004, pp. 703-709; B. A. Marinkovic et al. “Negative Thermal Expansion in Hydrated HZSM-5 Orthorhombic Zeolite,” Microporous and Mesoporous Materials 71 (2004) 117-124; Sang Soo Han et al., “Metal-Organic Frameworks Provide Large Negative Thermal Expansion Behavior,” J. Phys. Chem. C, 2007, 111, 15185-15191; and Lei Zhao et al, “Negative Thermal Expansion in Covalent Organic Framework COF-102,” J. Phys. Chem. C, 2009, 113 (39), pp. 16860-16862, all of which are incorporated herein in their entireties by reference.

The material from which the adsorber is formed and the pores formed in the material are selected to operate in one of two ways. In a first way, a first type of molecular sieve adsorber is configured to adsorb an oil lubricant fraction of lower molecular weight, smaller molecular size lubricant molecules when a threshold engine oil temperature is reached and to keep this fraction adsorbed whenever the temperature is at or above the threshold temperature. In this case, when the molecular sieve material has a positive thermal expansion with increasing temperature in the relevant temperature range the adsorbent pore size is too small below the threshold temperature to permit the oil lubricant fraction of lower molecular weight, smaller molecular size lubricants molecules to enter the pores but the molecular sieve material of the first type of adsorber expands at the threshold temperature to a size to permit the oil lubricant fraction of lower molecular weight, smaller molecular size lubricant molecules to enter the pores. However, as the temperature increases still further, the pores of the first adsorber do not expand sufficiently to release the adsorbed oil lubricant fraction of lower molecular weight, smaller molecular size lubricant molecules during operating temperatures for the lubrication system. When the molecular sieve material has a negative thermal expansion with increasing temperature in the relevant temperature range the pore size is too large below the threshold temperature to retain the oil lubricant fraction of lower molecular weight, smaller molecular size lubricant molecules in its pores but the molecular sieve material of the first type of adsorber contracts at the threshold temperature to a size that adsorbs the oil lubricant fraction of lower molecular weight, smaller molecular size lubricant molecules at the threshold temperature through further temperature increases during operation of the lubrication system. In a second way, a second type of molecular sieve adsorber is configured to adsorb higher molecular weight, larger molecular volume lubricant molecules at lower temperatures until a threshold lubricant temperature is reached, when the adsorbed fraction is released into the lubricant. In this case, when the molecular sieve material has a positive thermal expansion with increasing temperature in the relevant temperature range the adsorbent pore size is sized to adsorb the higher molecular weight, larger molecular volume lubricant molecules below the threshold temperature, but the molecular sieve material of the second type of adsorber expands at the threshold temperature to a size that permits the lubricant molecules of higher molecular weight, larger size lubricant molecules to desorb from the pores. When the molecular sieve material has a negative thermal expansion with increasing temperature in the relevant temperature range the adsorbent pore size decreases at the threshold temperature to force the lubricant molecules of higher molecular weight, larger molecular size in its pores to desorb.

FIG. 1 shows one brick 46, but a lubrication system may have a plurality of bricks of molecular sieve materials with the same or different pore sizes and thermal expansion behaviors. In various embodiments, a lubrication system may have one or more bricks of the first type of molecular sieve adsorber and one or more bricks of the second type of molecular sieve adsorber.

Employing a number of bricks of different molecular sieve materials and a base oil with corresponding base stock fractions that are adsorbed on one of the different molecular sieves in a given temperature range allows control of base stock oil viscosity through wide operating temperature ranges. The composition of the base oil can be modified to include lubricant molecules selected to better fit a pore size of a molecular sieve material being used.

In one example, a lubricant is used that contains at least three sizes of lubricant molecules, the different molecules having molecular sizes of 3 nm, 40 nm, and 90 nm. The weight fractions in the base oil of these lubricant molecules are 20 wt % of the fraction with molecular size 3 nm, 60 wt % of the fraction with molecular size 40 nm, and 20 wt % of the fraction with molecular size 90 nm. This oil is used with a first zeolite material having pore size of 3 nm and a capacity to adsorb the full 20 wt % fraction of the oil with molecular size 3 nm when the lubricating oil has a temperature at or above about 30° C. and a second zeolite material having a pore size of 90 nm and a capacity to adsorb the full 20 wt % fraction of the oil with molecular size 90 nm when the lubricating oil has a temperature at or below about 120° C. The 60 wt % of molecules with molecular size 40 nm remains unadsorbed at all operating temperatures.

Brick 40 may be attached to the sump by a fastener, adhesive, held within a strap or mesh restraint, by being formed with piece that slides into a slot or otherwise connects onto a fixture in the sump, or by another method. Preferably, the attachment is mechanical to avoid any contamination of the oil by chemicals from an adhesive.

In other embodiments (not shown), the molecular sieve material may have other shapes or may be of other sizes relative to the sump. In one embodiment, the molecular sieve material may substantially fill the sump. The molecular sieve material may also be embedded as nodules in anther material such as a foam or may be powder or beads contained in a porous enclosure.

A brick or other shape of molecular sieve material may be located in another part of the engine lubrication system instead of or in addition to being in the sump. For example a molecular sieve material may be in a fluid passage of the lubrication system 26 or may be located in a separate loop added to the lubrication system to contain the molecular sieve material.

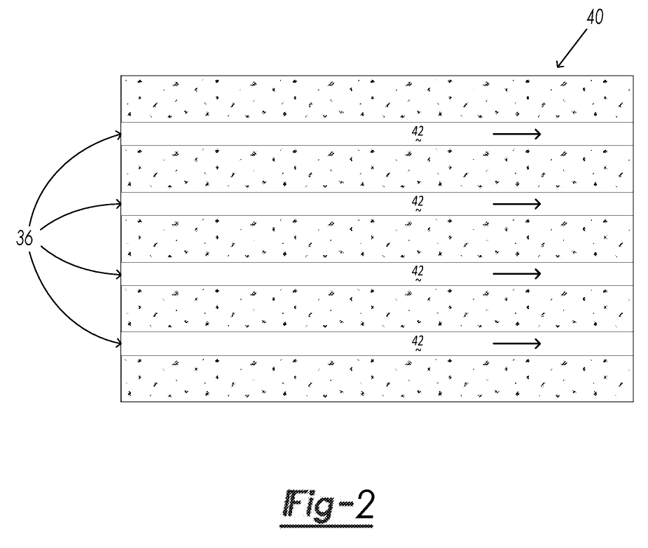

As shown in FIG. 2, brick 40 may include internal passages or channels 42 through which the oil 36 may flow. The internal channels increase the effective surface area of molecular sieve material with pores sized to adsorb a lubricant species of a particular molecular volume.

In various embodiments, the method and system use a lubricant that includes a poly(alpha-olefin) oil including one or more oligomers of the olefin, such as one or more oligomers of decene. In certain embodiments, the lubricant includes a species selected from dimers and trimers of decene and dodecene and a species selected from tetramers, pentamers, and hexamers of decene and dodecene. In this example, the system includes a first molecular sieve material having pore sizes of about 7 to 8 nm in a temperature range of above about 20° C. and a second molecular sieve material having pore sizes of about 90 to about 110 nm in a temperature range of below about 130° C.

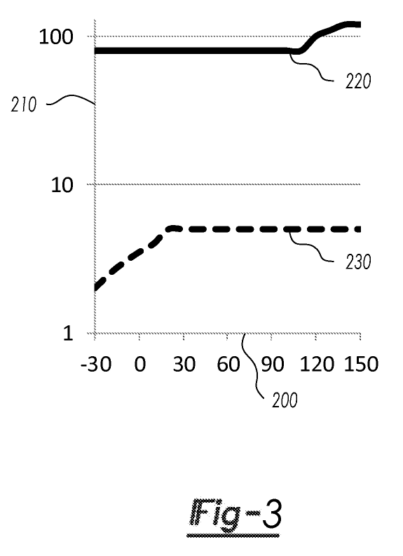

FIG. 3 shows one exemplary behavior for a lubrication system having a first molecular sieve material for adsorbing and desorbing a lower molecular weight oligomer and a second molecular sieve material for adsorbing and desorbing a higher molecular weight oligomer. In FIG. 3, y-axis 210 is the average pore size of the molecular sieve material, in nanometers; x-axis 200 is lubricant temperature, in degrees C. Line 230 represents the change in pore size over temperature for the first molecular sieve material. Line 220 represents the change in pore size over temperature for the second molecular sieve material. As shown in FIG. 3, when the sump temperature is low, such as less than about 20° C., the first molecular sieve material indicated by line 230 will have a pore size of less than the molecular size of the lower molecular weight oligomer so that the lower molecular weight oligomer will not be adsorbed but will remain in the lubricant. At temperatures above about 20° C., the pore size of the first molecular sieve material increases sufficiently so that the lower molecular weight oligomer is adsorbed. The second molecular sieve material, indicated by line 220, adsorbs the higher molecular weight oligomer until the lubricant temperature reaches about 130° C., when the pores of the second molecular sieve material expand sufficiently to allow the higher molecular weight oligomer molecules to leave the second molecular sieve material to mix in the lubricant.

A third, medium molecular weight oligomer having a molecular weight between the lower and higher molecular weight oligomers remains in the lubricant mixture over the whole temperature range.

In another embodiment, the lubrication system is a transmission lubrication system. A transmission lubrication system includes a transmission fluid sump or reservoir, pump, pickup and transmission fluid distribution system. The molecular sieves may be located in the sump or in a separate unit in fluid connection with the transmission fluid distribution system. In yet another embodiment, the lubrication system is a lubrication system for an automotive vehicle driveline differential, which includes a sump containing gear oil. The molecular sieve material or materials may be located in the sump.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A lubrication system in a machine comprising
(a) a lubricant comprising a plurality of differently-sized species of lubricant molecules;
(b) a sump for the lubricant;
(c) a pump that circulates the lubricant to an area of the machine for lubrication; and
(d) a molecular sieve in the lubrication system that adsorbs a species of lubricant molecules in a predetermined lubricant temperature range and desorbs the species of lubricant molecules at temperatures outside the predetermined lubricant temperature range.

2. A lubrication system in a machine according to claim 1, wherein the first molecular sieve is in the sump.

3. A lubrication system in a machine according claim 1, further comprising a second molecular sieve in the lubrication system that adsorbs a second, larger size species of lubricant molecules in a second, higher predetermined lubricant temperature range and desorbs the second size species of lubricant molecules at temperatures outside the second predetermined lubricant temperature range.

4. A lubrication system in a machine according to claim 3, comprising a third species of lubricant molecules that is not adsorbed by either of the molecular sieve or the second molecular sieve.

5. A lubrication system in a machine according to claim 1, wherein the molecular sieve and, if present, the second molecular sieve is or are mechanically affixed in the lubrication system.

6. A lubrication system in a machine according to claim 1, wherein the molecular sieve and, if present, the second molecular sieve comprises or comprise channels through which the lubricant flows and pores along the channels sized to adsorb the species of lubricant molecules in the predetermined lubricant temperature range.

7. A lubrication system in a machine according to claim 1, wherein the molecular sieve and, if present, the second molecular sieve is or are selected from zeolites, metal organic frameworks, and covalent organic frameworks.

8. A lubrication system in a machine according to claim 1, wherein the molecular sieve or, if present, the second molecular sieve has a combination of pore sizes selected to adsorb two species of lubricant molecules each in different temperature ranges.

9. A lubrication system in a machine according to claim 1, wherein the machine is an automotive vehicle, an aircraft, a ship, a boat, a locomotive, a motorcycle, or a machine tool.

10. A method of controlling viscosity of a lubricant comprising a plurality of lubricant species, each lubricant species having lubricant molecules of different molecular sizes, over an operating temperature range of a lubrication system, comprising
circulating the lubricant in the lubrication system over the operating temperature range, wherein the range has as endpoints an initial temperature and a higher temperature that is reached during operation, and
contacting the lubricant with at least one molecular sieve that adsorbs molecules of at least one lubricant species between a threshold temperature and a second temperature in the operating range.

11. A method according to claim 10, wherein the second temperature is one of the endpoints.

12. A method according to claim 10, wherein the molecular sieve has pore sizes of about 7 to 8 nm in a temperature range of above about 20° C. to the higher temperature or has pore sizes of about 90 to about 110 nm in a temperature range from the initial temperature to about 130° C.

13. An automotive vehicle, comprising an engine oil lubrication system comprising an oil sump, an oil pump that circulates the oil from the oil sump through the lubrication system, an oil comprising a plurality of differently-sized species of lubricant molecules; and a molecular sieve in the lubrication system that adsorbs a species of lubricant molecules in a predetermined lubricant temperature range and desorbs the species of lubricant molecules at temperatures outside the predetermined lubricant temperature range.

14. An automotive vehicle according to claim 13, wherein the molecular sieve has pore sizes of about 7 to 8 nm at temperatures above about 20° C. or has pore sizes of about 90 to about 110 nm at temperatures below about 130° C.

15. An automotive vehicle according to claim 13, wherein the molecular sieve material is in the form of a membrane or a monolith or is in the form of beads enclosed in a container having screened ends to retain the molecular cell material through which the lubricant may flow or beads or powders embedded in an open-cell foam through which the lubricant may flow.
